(19) United States
(12) Patent Application Publication
(10) Pub. No.: US 2018/0267345 A1
(43) Pub. Date: Sep. 20, 2018

(54) DISPLAY DEVICE AND DISPLAY PANEL THEREOF

(71) Applicants: HKC Corporation Limited; Chongqing HKC Optoelectronics Technology Co., Ltd., Chongqing (CN)

(72) Inventor: Yu-Jen CHEN, Chongqing (CN)

(21) Appl. No.: 15/561,679

(22) PCT Filed: Aug. 18, 2017
(86) PCT No.: PCT/CN2017/097958

§ 371 Date: Sep. 26, 2017

(30) Foreign Application Priority Data
Mar. 15, 2017 (CN) 201710154300.9

(51) Int. Cl. G02F 1/1333; G02F 1/1335

(52) U.S. Cl. CPC G02F 1/1333; G02F 2001/133374; G02F 1/133528; G02F 1/133512

(57) ABSTRACT

This application relates to a display panel, including a display region and a shading region. The shading region surrounds the display region. An identification region is disposed on the shading region. The identification region is a light transmissive area having a target identifier pattern. By means of the display panel, a target identifier can be embedded, and integrity of the display panel is not destroyed. In addition, by means of the display panel, no attachment identifier needs to be disposed separately, reducing costs and improving user experience.

### BACKGROUND

### Technical Field

This application relates to the field of display technologies, and particularly, to a display device and a display panel.

### Related Art

A display panel of a conventional display device includes a visible region, a shading region, and a frame. The logo is directly attached to a surface of a front frame. As people impose higher requirements on display performance, more display panels start to use partial frames, that is, only a bottom frame is disposed. The logo is attached to a surface of the bottom frame. No frame is disposed for a frameless display panel, and as a result, it is inappropriate to design the logo on the front screen. Integrity of a panel may be destroyed when the logo or the like is directly attached to a shading region, and in this case, the frameless design is meaningless.

### SUMMARY

In view of this, it is necessary to provide a display device having relatively low costs and relatively good integrity, and a display panel thereof.

A display panel includes a display region and a shading region surrounding the display region, wherein an identification region is disposed on the shading region, and the identification region is a light transmissive area having a target identifier pattern.

The identification region is disposed on the shading region of the display panel. The identification region is the light transmissive area having the target identifier pattern, so that a target identifier can be directly displayed by means of the light transmissive area, the target identifier is embedded, and integrity of the display panel is not destroyed. In addition, by means of the display panel, no attachment identifier needs to be disposed separately, reducing costs and improving user experience.

In an embodiment, the light transmissive area is a transparent area or a translucent area.

In an embodiment, the shading region includes a shading layer, and the identification region is disposed on the shading layer.

In an embodiment, the shading region further includes an identification device embedded in the display panel, and a surface reflectance of the identification device is greater than a surface reflectance of a non-light transmissive area on the shading region.

In an embodiment, the identification device is a conductive metal layer having the target identifier pattern.

In an embodiment, at least a part of the light transmissive area is located above a backlight source of the display panel.

In an embodiment, the display panel is a liquid crystal display panel, the liquid crystal display panel includes a lower polarizer, a lower substrate, a liquid crystal layer, an upper substrate, and an upper polarizer disposed sequentially, the shading region further includes a shading layer between the upper polarizer and the upper substrate, and the identification region is disposed on the shading layer.

In an embodiment, the shading region further includes an identification device embedded in the display panel, the identification device is located between the liquid crystal layer and the shading layer, and a surface reflectance of the identification device is greater than a surface reflectance of the non-light transmissive area on the shading layer.

In an embodiment, the identification device is a logo or an indicator.

A display device includes a display drive component, and further includes the display panel described in any one the foregoing embodiments, where the display drive component is electrically connected to the display panel, to drive the display panel.

In an embodiment, the light transmissive area is a transparent area or a translucent area.

In an embodiment, the shading region includes a shading layer, and an identification region is disposed on the shading layer.

In an embodiment, the shading region further includes an identification device embedded in the display panel, and a surface reflectance of the identification device is greater than a surface reflectance of a non-light transmissive area on the shading region.

In an embodiment, the identification device is a conductive metal layer having a target identifier pattern.

In an embodiment, at least a part of the light transmissive area is located above a backlight source of the display panel.

In an embodiment, the display panel is a liquid crystal display panel, the liquid crystal display panel includes a lower polarizer, a lower substrate, a liquid crystal layer, an upper substrate, and an upper polarizer disposed sequentially, the shading region further includes a shading layer between the upper polarizer and the upper substrate, and the identification region is disposed on the shading layer.

In an embodiment, the shading region further includes an identification device embedded in the display panel, the identification device is located between the liquid crystal layer and the shading layer, and a surface reflectance of the identification device is greater than a surface reflectance of a non-light transmissive area on the shading layer.

In an embodiment, the identification device is a logo or an indicator.

A display panel includes a display region and a shading region. The shading region surrounds the display region. An identification region is disposed on the shading region, and the identification region is a light transmissive area having a target identifier pattern. The shading region further includes an identification device embedded in the display panel, and a surface reflectance of the identification device is greater than a surface reflectance of a non-light transmissive area on the shading region. The display panel is a liquid crystal display panel. The liquid crystal display panel includes a lower polarizer, a lower substrate, a liquid crystal layer, an upper substrate, and an upper polarizer disposed sequentially. The shading region further includes a shading layer located between the upper polarizer and the upper substrate. The identification region is disposed on the shading layer.

### BRIEF DESCRIPTION OF THE DRAWINGS

FIG. 1 is a front view of a display panel in an embodiment;

FIG. 2 is a partial cross-sectional view of the display panel in FIG. 1;

FIG. 3 is a partial cross-sectional view of a display panel in another embodiment;

FIG. 4 is a partial cross-sectional view of a liquid crystal display in an embodiment; and

FIG. 5 is a partial cross-sectional view of a liquid crystal display in another embodiment.

### DETAILED DESCRIPTION

To make the objectives, technical solutions, and advantages of this application clearer and more comprehensible, the following further describes this application in detail with reference to the accompanying drawings and embodiments. It should be understood that the specific embodiments described herein are merely used to explain this application but are not intended to limit this application.

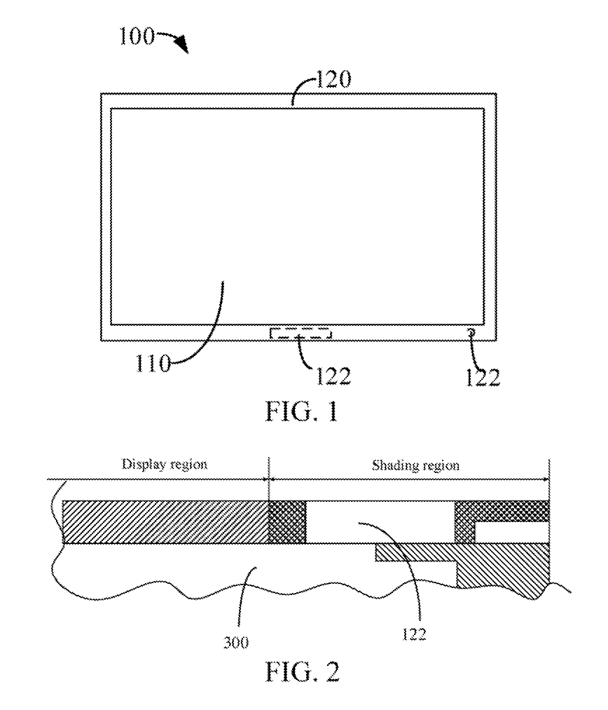

FIG. 1 is a front view of a display panel 100 in an embodiment. The display panel 100 includes a display region 110 and a shading region 120. The shading region 120 surrounds the display region 110. In this embodiment, no frame structure may be disposed around the display panel 100, thereby implementing frameless display, and satisfying use requirements of a user.

In this embodiment, the display panel 100 is, for example, a liquid crystal display panel, an organic light-emitting diode display panel, an electroluminescent display panel, or a plasma display panel.

An identification region is disposed on the shading region 120. The identification region is a light transmissive area 122 having a target identifier pattern. The target identifier pattern may be a logo, an indicator pattern, or another pattern having a function of a target identifier. Specifically, the shading region 120 includes a shading layer. The light transmissive area 122 is disposed on the shading layer. The light transmissive area 122 may be made of a transparent material or a translucent material. Because the light transmissive area 122 has the target identifier pattern, the light transmissive area 122 may be used as an identification device. In this case, no identification device needs to be embedded in the display panel 100 separately, thereby reducing costs and improving user experience. In addition, compared with a method of directly attaching an identifier to the shading region 120, because the light transmissive area 122 is a part of the shading region 120, integrity of the display panel 100 may not be destroyed, and frameless display can be implemented. In this embodiment, at least a part of the light transmissive area 122 is located above a backlight source 300 of the display panel 100 (as shown in FIG. 2), so that the backlight source 300 is used as a light source of the light transmissive area 122 (that is, the identification device), to illuminate the identification device, and form a luminescent identifier.

FIG. 3 is a partial cross-sectional view of a display panel 100 in another embodiment. In this embodiment, the shading region 120 further includes an identification device 400. The identification device 400 is embedded in the shading region 120, and corresponds to a location of the identification region (that is, the light transmissive area 122). A reflectance of a surface of the identification device 400 opposite to the light transmissive area 122 is greater than a reflectance of a non-light transmissive area on the shading region 120, to display the identification device 400 by reflecting the external light, forming a reflective identifier.

In an embodiment, the identification device 400 is a conductive metal layer having the target identifier pattern. It may be understood that the identification device 400 includes but is not limited to the conductive metal layer.

The identification region is disposed on the shading region 120 of the display panel 100. The identification region is the light transmissive area 122 having the target identifier pattern, so that a target identifier can be directly displayed by means of the light transmissive area 122, the target identifier is embedded, and integrity of the display panel 100 is not destroyed. In addition, by means of the display panel 100, no attachment identifier needs to be disposed separately, reducing costs and improving user experience.

In the display panel 100, the backlight source may be directly used as the light source of the light transmissive area 122, or an external light source is directly used as the light source of the light transmissive area 122, so that no light source needs to be disposed in the display panel 100, effectively reducing space needed for identifier displaying. In addition, the identifier can be displayed without increasing a width of the shading region 120, implementing frameless display.

This application further provides a display device, including a display drive component and the display panel described in any one of the foregoing embodiments. The display drive component is electrically connected to the display panel, to drive the display panel. The display device may be a device, such as a television, a computer, a tablet computer, or a mobile phone. A part of the display device using the display panel can be frameless or the display device using the display panel is completely frameless, thereby satisfying people's use requirements.

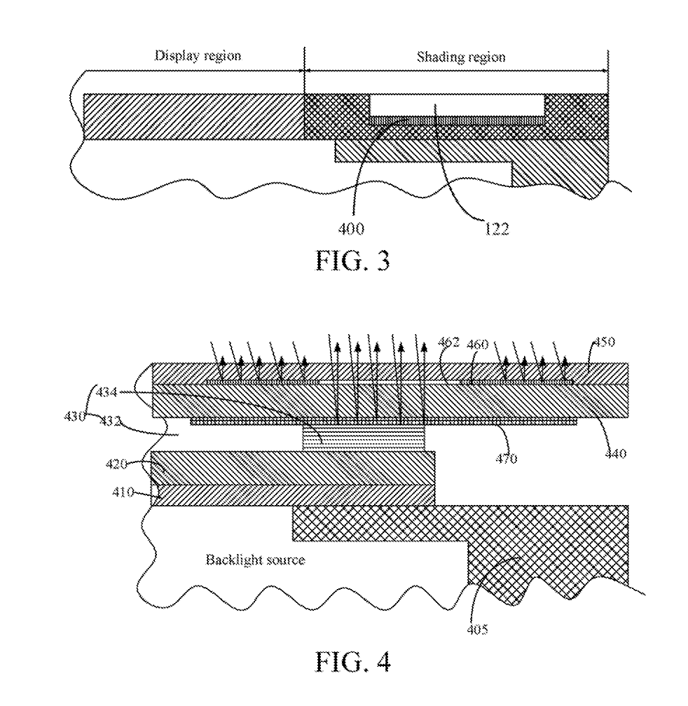

The following further describes the display device in this embodiment by using an example wherein the display device is a liquid crystal display. Referring to FIG. 4, the liquid crystal display includes a frame 405 and a liquid crystal display panel fixed on the frame 405, and further includes a backlight source. The liquid crystal display panel includes a lower polarizer 410, a lower substrate 420, a liquid crystal layer 430, an upper substrate 440, and an upper polarizer 450 disposed sequentially along a light emitting direction of the backlight source. 432 represents liquid crystals on the liquid crystal layer, and 434 represents a frame glue surrounding the liquid crystals. A shading layer 460 is further disposed on the shading region of the liquid crystal display panel. The shading layer 460 is located between the upper polarizer 450 and the upper substrate 440. An identification region is disposed on the shading layer 460. The identification region is a light transmissive area 462 having a target identifier pattern. The identification device is located between the liquid crystal layer 430 and the shading layer 460. In this embodiment, the identification device is located between the liquid crystal layer 430 and the upper substrate 440. The identification device is a conductive metal layer 470 having the target identifier pattern. A reflectance of the conductive metal layer 470 is greater than a reflectance of a non-light transmissive area of the shading layer 460, to display the identifier by means of the external light.

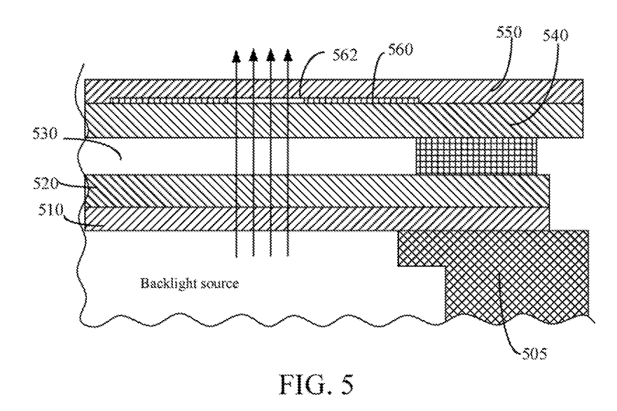

FIG. 5 is a schematic partial view of a liquid crystal display in another embodiment. The liquid crystal display includes a frame 505 and a liquid crystal display panel fixed on the frame 505, and further includes a backlight source. The liquid crystal display panel includes a lower polarizer 510, a lower substrate 520, a liquid crystal layer 530, an upper substrate 540, and an upper polarizer 550 disposed sequentially along a light emitting direction of the backlight source. A shading layer 560 is further disposed on a shading region of the liquid crystal display panel. The shading layer 560 is located between the upper polarizer 550 and the upper substrate 540. An identification region is disposed on the shading layer 560. The identification region is a light transmissive area 562 having a target identifier pattern. In this embodiment, the light transmissive area 562 of the shading layer 560 is completely located above the backlight source of the liquid crystal display, so that the backlight source is used as a light source of the light transmissive area 562, to display the identifier. In another embodiment, only a part of the light transmissive area 562 of the shading layer 560 may be located above the backlight source of the liquid crystal display.

The identification region is disposed on the shading region of the liquid crystal display. The identification region is the light transmissive area 462 (562) having the target identifier pattern, so that a target identifier can be directly displayed by means of the light transmissive area 462 (562), the target identifier is embedded, and integrity of the liquid crystal display panel is not destroyed. In addition, by means of the liquid crystal display panel, no attachment identifier needs to be disposed separately, reducing costs and improving user experience.

In the liquid crystal display, the backlight source may be directly used as the light source of the light transmissive area 462 (562), or an external light source is directly used as the light source of the light transmissive area 462 (562), so that no light source needs to be disposed in the liquid crystal display 100, effectively reducing space needed for identifier displaying. In addition, the identifier can be displayed without increasing a width of the shading region, implementing frameless display.

Technical features of the foregoing embodiments may be combined in any way. For brevity of descriptions, not all possible combinations of the technical features in the foregoing embodiments are described. Provided that no contradiction exists between the combinations of these technical features, it should be considered that the combinations should fall within the scope of this specification.

The foregoing embodiments merely describe several implementation manners of this application, and their description is specific and detailed, but cannot therefore be understood as a limitation to the patent scope of this application. It should be pointed out that a person of ordinary skill in the art can make several modifications and improvements without departing from the idea of this application and these modifications and improvements all belong to the protection scope of this application. Therefore, the protection scope of this application should be subject to the protection scope of the appended claims.

What is claimed is:

1. A display panel, comprising:
a display region; and
a shading region, surrounding the display region, wherein an identification region is disposed on the shading region, and the identification region is a light transmissive area having a target identifier pattern.

2. The display panel according to claim 1, wherein the light transmissive area is a transparent area or a translucent area.

3. The display panel according to claim 1, wherein the shading region comprises a shading layer.

4. The display panel according to claim 3, wherein the identification region is disposed on the shading layer.

5. The display panel according to claim 1, wherein the shading region further comprises an identification device embedded in the display panel, and a surface reflectance of the identification device is greater than a surface reflectance of a non-light transmissive area on the shading region.

6. The display panel according to claim 5, wherein the identification device is a conductive metal layer having the target identifier pattern.

7. The display panel according to claim 1, wherein at least a part of the light transmissive area is located above a backlight source of the display panel.

8. The display panel according to claim 1, wherein the display panel is a liquid crystal display panel, the liquid crystal display panel comprises a lower polarizer, a lower substrate, a liquid crystal layer, an upper substrate, and an upper polarizer disposed sequentially, the shading region further comprises a shading layer between the upper polarizer and the upper substrate, and the identification region is disposed on the shading layer.

9. The display panel according to claim 8, wherein the shading region further comprises an identification device embedded in the display panel, the identification device is located between the liquid crystal layer and the shading layer, and a surface reflectance of the identification device is greater than a surface reflectance of a non-light transmissive area on the shading layer.

10. The display panel according to claim 9, wherein the identification device is a logo or an indicator.

11. A display device, comprising:
a display drive component; and
a display panel, comprising:
a display region; and
a shading region, surrounding the display region, wherein an identification region is disposed on the shading region, and the identification region is a light transmissive area having a target identifier pattern, wherein
the display drive component is electrically connected to the display panel, to drive the display panel.

12. The display device according to claim 11, wherein the light transmissive area is a transparent area or a translucent area.

13. The display device according to claim 11, wherein the shading region comprises a shading layer, and the identification region is disposed on the shading layer.

14. The display device according to claim 11, wherein the shading region further comprises an identification device embedded in the display panel, and a surface reflectance of the identification device is greater than a surface reflectance of a non-light transmissive area on the shading region.

15. The display device according to claim 14, wherein the identification device is a conductive metal layer having the target identifier pattern.

16. The display device according to claim 11, wherein at least a part of the light transmissive area is located above a backlight source of the display panel.

17. The display device according to claim 11, wherein the display panel is a liquid crystal display panel, the liquid crystal display panel comprises a lower polarizer, a lower substrate, a liquid crystal layer, an upper substrate, and an upper polarizer disposed sequentially, the shading region further comprises a shading layer between the upper polarizer and the upper substrate, and the identification region is disposed on the shading layer.

18. The display device according to claim 17, wherein the shading region further comprises an identification device embedded in the display panel, the identification device is located between the liquid crystal layer and the shading layer, and a surface reflectance of the identification device is greater than a surface reflectance of a non-light transmissive area on the shading layer.

19. The display device according to claim 18, wherein the identification device is a logo or an indicator.

20. A display panel, comprising:
a display region; and
a shading region, surrounding the display region, wherein an identification region is disposed on the shading region, and the identification region is a light transmissive area having a target identifier pattern, wherein
the shading region further comprises an identification device embedded in the display panel, and a surface reflectance of the identification device is greater than a surface reflectance of a non-light transmissive area on the shading region; and
the display panel is a liquid crystal display panel, the liquid crystal display panel comprises a lower polarizer, a lower substrate, a liquid crystal layer, an upper substrate, and an upper polarizer disposed sequentially, the shading region further comprises a shading layer between the upper polarizer and the upper substrate, and the identification region is disposed on the shading layer.
